(19) United States
(12) Patent Application Publication
(10) Pub. No.: US 2011/0279851 A1
(43) Pub. Date: Nov. 17, 2011

(54) RSVP SYSTEM AND METHOD FOR AN ONLINE STATIONERY OR GREETING CARD SERVICE

(76) Inventors: Kelly Berger, Los Altos, CA (US); Adnan Asar, Sunnyvale, CA (US); Ramin Naimi, Saratoga, CA (US); Lily Liang, San Francisco, CA (US); Kevin Chang, Sunnyvale, CA (US); Krys Taylor, Sunnyvale, CA (US); Michael Iskander Boulos, Concord, CA (US); Karthik Sadhasivam, San Jose, CA (US)

(21) Appl. No.: 12/779,825

(22) Filed: May 13, 2010

(51) Int. Cl. G06F 3/12; G06F 15/16; G06F 3/01

(52) U.S. Cl. 358/1.15; 715/738

(57) ABSTRACT

Described herein is a system and method for requesting and managing RSVP responses to invitations created within an online stationery service. For example, one embodiment of a system implemented within an online stationery service comprises: a stationery personalization engine providing an end user with a set of selectable stationery templates, the stationery personalization engine receiving an indication that an end user has selected a particular one of the stationery templates, and generating personalized stationery with the selected template based on user input, the personalized stationery comprising an invitation to an event and requesting RSVP responses from invitees; an RSVP service including logic for dynamically generating a network address in response to placement of a stationery order by the user, the RSVP service responsively generating an RSVP Website accessible using the network address and configured to receive the RSVP responses from invitees; and a print module to generate and transmit a print job for printing the personalized stationery including the network address of the RSVP Website for receiving the RSVP responses; wherein in response to an invitee accessing the Website using the network address, the RSVP service provides one or more Web pages allowing the invitee to submit an RSVP response.

### BACKGROUND

1. Field of the Invention

This invention relates generally to the field of network data processing systems. More particularly, the invention relates to an RSVP system and method for an online stationery and/or greeting card system.

2. Description of the Related Art

Current online stationery services allow end users to select stationery for events such as wedding invitations, birth announcements, and baptism announcements. In addition, current online greeting card services allow users to select greeting cards for different occasions such as birthdays and holidays. These services typically print the stationery and/or greeting cards and mail them to the end user. The end user manually reviews the order and mails the printed stationery and/or greeting cards to the recipients.

In cases where a response is required from the recipients, RSVP cards may be printed for the end user and included in the stationery/card mailing. The recipient must then fill out the RSVP card (indicating whether the recipient will be attending the event) and mail the RSVP card back to the end user. Another common practice is to print contact information such as an email address or telephone number on the invitation card, and the recipient uses this contact method to respond to the sender. The end user must then keep track of RSVP responses and notify those users who have failed to respond prior to the deadline. This often turns into a burdensome task for the end user, particularly for large events with hundreds or potentially thousands of invitees.

Consequently, improved techniques for managing RSVP responses are needed.

### SUMMARY

Described herein is a system and method for requesting and managing RSVP responses to printed invitations created within an online stationery service. For example, one embodiment of a system implemented within an online stationery service comprises: a stationery personalization engine providing an end user with a set of selectable stationery templates, the stationery personalization engine receiving an indication that an end user has selected a particular one of the stationery templates, and generating personalized stationery with the selected template based on user input, the personalized stationery comprising an invitation to an event and requesting RSVP responses from invitees; an RSVP service including logic for dynamically generating a network address in response to placement of a stationery order by the user, the RSVP service responsively generating an RSVP Website accessible using the network address and configured to receive the RSVP responses from invitees; and a print module to generate and transmit a print job for printing the personalized stationery including the network address of the RSVP Website for receiving the RSVP responses; wherein in response to an invitee accessing the Website using the network address, the RSVP service provides one or more Web pages allowing the invitee to submit an RSVP response. One embodiment of the RSVP service also provides online tools to allow the event host to easily manage the RSVP responses, make changes to the event information, and communicate with all the guests based on their response status.

### BRIEF DESCRIPTION OF THE DRAWINGS

A better understanding of the present invention can be obtained from the following detailed description in conjunction with the following drawings, in which:

FIG. 1 illustrates a system architecture of a stationery/card service which includes a contacts database.

FIG. 2 illustrates a method according to one embodiment of the invention.

FIG. 3 illustrates a system architecture for an online photo service which includes a contacts database and a calendar database.

FIG. 4 illustrates a system architecture according to one embodiment of the invention.

FIG. 5 illustrates an RSVP service according to one embodiment of the invention.

FIGS. 6a-c illustrate methods executed by an RSVP service according to embodiments of the invention.

FIG. 7 illustrates a GUI for selecting an RSVP service according to one embodiment of the invention.

FIG. 8 illustrates RSVP service URLs generated in one embodiment of the invention.

FIG. 9 illustrates RSVP preference settings according to one embodiment of the invention.

FIG. 10 illustrates an event details screen according to one embodiment of the invention.

FIG. 11 illustrates a guests screen according to one embodiment of the invention.

FIG. 12 illustrates one embodiment of a window for adding a guest and/or for submitting an RSVP response.

FIG. 13 illustrates one embodiment of a window for inviting additional guests.

### DETAILED DESCRIPTION

Described below is an RSVP system and method implemented within a stationery and/or card service. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

The assignee of the present application has developed an online stationery and greeting card system as described in the following co-pending patent applications, which are incorporated herein by reference:

SYSTEM AND METHOD FOR MANAGING CONTACTS AND CALENDARS WITHIN AN ONLINE CARD SYSTEM, Ser. No. 12/702,932, filed Feb. 9, 2010;

SYSTEM, METHOD AND GRAPHICAL USER INTERFACE FOR MANAGING CONTACTS AND CALENDARS WITHIN AN ONLINE CARD SYSTEM, Ser. No. 12/703,051, filed Feb. 9, 2010;

SYSTEM, METHOD AND GRAPHICAL USER INTERFACE FOR MANAGING CONTACTS AND CALENDARS WITHIN AN ONLINE CARD SYSTEM, Ser. No. 12/703,130, filed Feb. 9, 2010;

SYSTEM AND METHOD FOR PROCESSING PERSONALIZED STATIONERY DESIGNS AND SELECTING FULFILLMENT ORDER SITES, Ser. No. ______, filed ______; and

SYSTEM AND METHOD FOR DESIGNING AND GENERATING ONLINE STATIONERY, Ser. No. ______, filed ______.

Certain aspects of the systems described in these applications (hereinafter referred to as the “co-pending applications”) may be used for implementing an RSVP service for managing RSVP responses as described herein. As such, system architectures described in the co-pending applications will first be described, following by a detailed description of the RSVP system and method.

### Embodiments Described in Co-Pending Applications

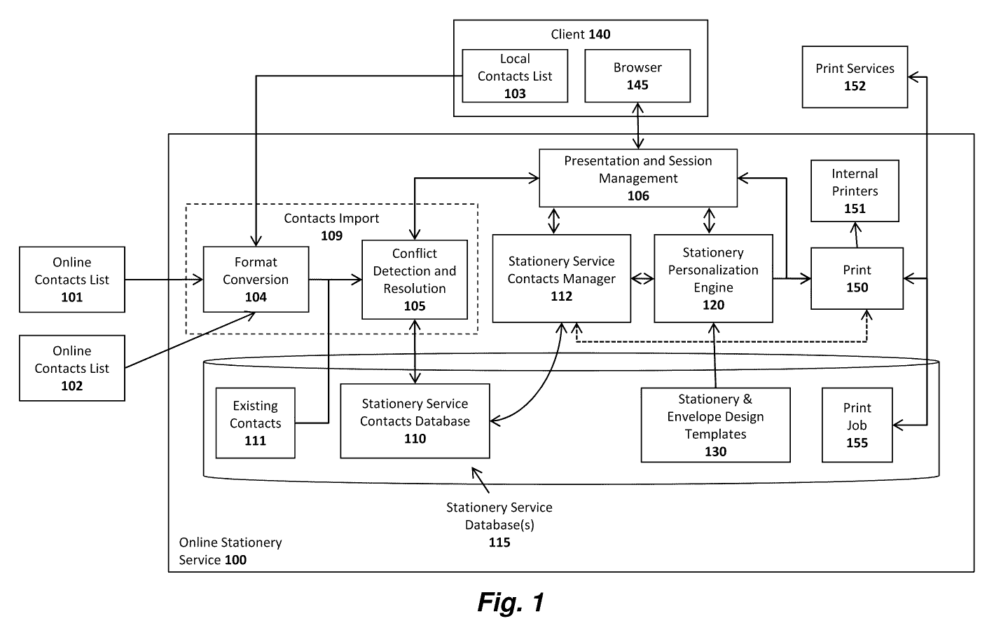

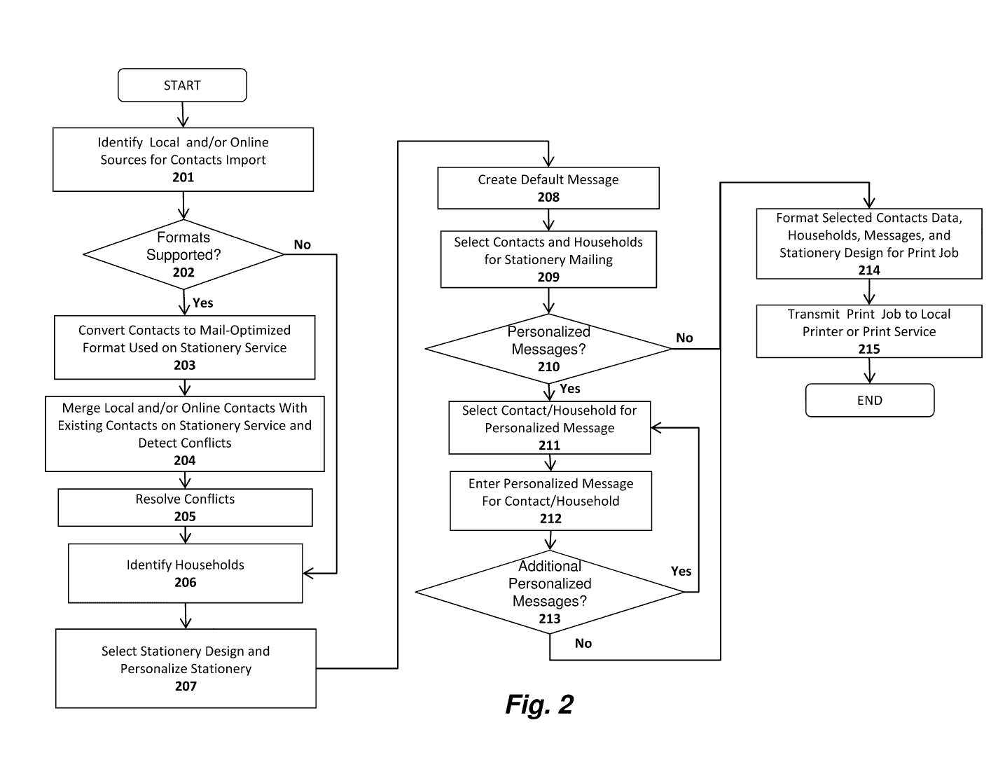

FIG. 1 illustrates one embodiment of a system architecture importing and managing contacts within an online stationery service 200 and FIG. 2 illustrates a corresponding method. One embodiment of the online stationery service 100 merges contact data from multiple different sources and then converts the contact data into a format which is optimized for online stationery mailing functions. A brief overview of the method illustrated in FIG. 2 will now be provided within the context of the architecture shown in FIG. 1. It should be noted, however, that the underlying principles of the invention are not limited to the specific architecture shown in FIG. 1.

At 201, a contacts import module 109 manages the importation of contacts from various local and/or online contact databases identified by the end user. In the illustrated embodiment, the contacts import module 109 comprises a format conversion module 104 and a conflict detection and resolution module 105. As shown in FIG. 1, the format conversion module 104 reads contacts data from online contacts databases 101-102; local contacts databases 103 (i.e., “local” to the user's client computer 140); and/or existing contacts 111 already stored on the online stationery service 100 (e.g., the end user may have already established an account on the online stationery service 100 to send stationery and may have entered information for a set of contacts 111). If the online/local contact formats are supported, determined at 202, then at 203, the format conversion module converts the contacts to a format optimized for use on an online stationery service 100. To perform the format conversion, the format conversion module 104 parses the contact data in source data structure (e.g., the CSV file, vCard file, etc), extracts the data, and assigns the data to appropriate data fields in the new data structure. Various well known techniques for converting data from one format to another may be employed by the format conversion module 104. Once converted (and following conflict detection described below), the contacts data is stored in its new format within a contacts database 110 on the stationery service. Various features associated with this new data format are described in detail below.

At 204, a conflict detection and resolution module 105 merges the local and/or online contacts with existing contacts 111 already stored on the online stationery service 100 and detects any conflicts which may result from the merge operation. A conflict may result if one or more contacts being imported are already stored within the existing contacts database 111. In such a case, the conflict detection and resolution module 105 resolves the conflicts at 205 using a set of conflict resolution rules (described below). Once all conflicts have been resolved, the data is persisted within the contacts database 110 and made accessible to end users via the stationery service contacts manager 112. In one embodiment, the contacts database 110 is implemented using mySQL. However, various different database formats may be employed while still complying with the underlying principles of the invention (e.g., Microsoft SQL, IBM SQL, etc).

At 207, the user identifies one or more “households” within the stationery service contacts database 110. As described below, households are specialized groups of contacts who live at the same address. The concept of a “household” is a particularly useful abstraction for an online stationery service 100 which mails stationery on behalf of a user.

As illustrated in FIG. 1, in one embodiment, all operations to the stationery service contacts database 110 occur through the stationery service contacts manager 112. That is, the stationery service contacts database 110 is used for persistent storage of contacts data containing the features described herein and the stationery service contacts manager 112 is the application-layer program code used to perform operations on the stationery service contacts database 110 as described below. The presentation and session management logic 106 comprises the program code for maintaining user sessions and for dynamically generating Web pages containing (among other things) the graphical user interface (GUI) features for manipulating contacts data as illustrated herein.

Returning to the method of FIG. 2, at 207, the user selects and personalizes a stationery design. In one embodiment, this is accomplished with a stationery personalization engine 120 such as that described in co-pending application entitled SYSTEM AND METHOD FOR DESIGNING AND GENERATING ONLINE STATIONERY, Ser. No. 12/188,721, filed Aug. 8, 2008, which is assigned to the assignee of the present application and which is incorporated herein by reference. In one embodiment, the stationery personalization engine 120 performs all of the functions described in the co-pending application as well as the additional functions described herein (e.g., selecting contacts/households for a stationery mailing via the stationery service contacts manager 112, selecting between a default message or a personal message for the contacts/households, etc).

At 208, the end user creates a default message to be used for a stationery mailing and, at 209, the contacts and/or households for the mailing are identified by the end user. If the user wishes to include a personalized message in lieu of the default message for one or more contacts/households, determined at 210, then the user selects a contact/household at 211 and enters the personalized message for the contact/household at 212. If any additional personalized messages are to be included, determined at 213, then steps 211 and 212 are repeated until all personalized messages have been entered.

At 214, all of the information related to the stationery order, including the selected stationery design, default messages, personalized messages and associated contacts and households are formatted for printing by a print module 150 which generates a print job 155. The formatting may include converting the stationery data mentioned above into a format usable by a particular printer. By way of example, a letter press printer may require different formatting than a digital press printer. In one embodiment, the specifications for the print job are encapsulated as metadata in an Extensible Markup Language (“XML”) document and transmitted to an external print service 152. In one embodiment, the XML document includes a hyperlink (e.g., a URL) to the formatted print job 155 on the online stationery service 100. The print service 152 then accesses the print job by selecting the hyperlink. Regardless of how the print job is accessed, at 215, the formatted print job 155 is transmitted to either an internal printer 151 or an external print service 152 (e.g., over the Internet). Once printing is complete, the online stationery service 100 or the print service 152 mails the stationery to the contacts and/or households identified by the end user.

Having provided an overview of the method set forth in FIG. 2 and the architecture illustrated in FIG. 1, various specific details associated with managing contacts, generating print jobs and mailing stationery from an online stationery service 100 will now be provided. It should be noted, however, that the underlying principles of the invention are not limited to the particular architecture shown in FIG. 1 or the particular method set forth in FIG. 2.

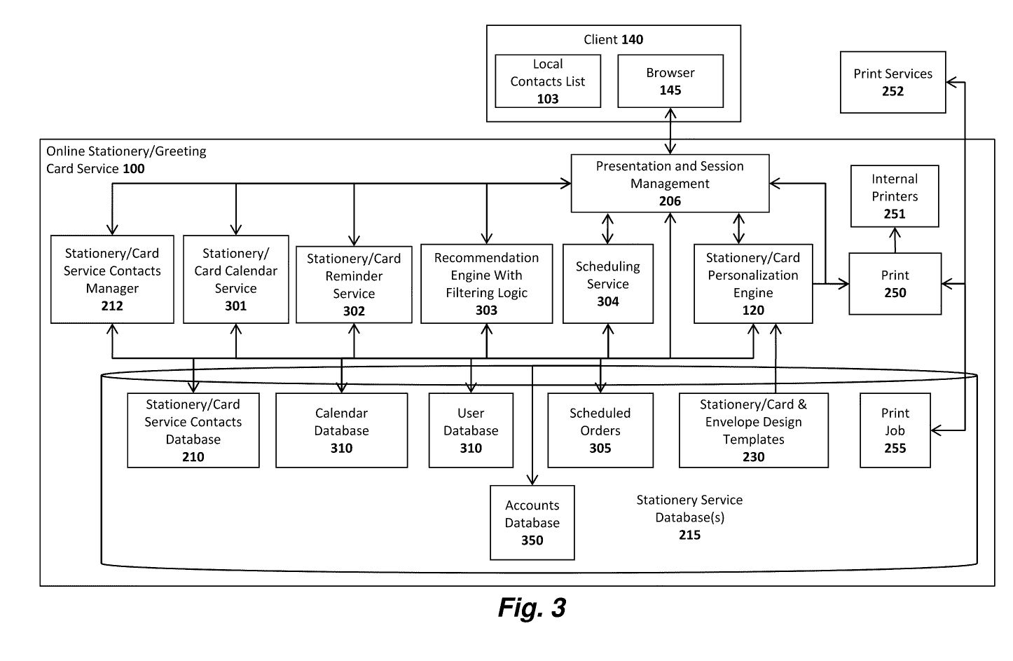

FIG. 3 illustrates one embodiment of a system architecture which integrates contacts and calendar data and includes additional modules for generating reminders, filtered recommendations, and for scheduling delivery of greeting cards/stationery. Specifically, in addition to the system components illustrated in FIG. 2, this embodiment includes a calendar service 301, a reminder service 302, a recommendation engine with filtering logic 303 and a scheduling service 304. The stationery/card service illustrated in FIG. 3 also includes a stationery service calendar database 310 for storing calendar data, a scheduled orders database 305 for storing order schedule data, a user database 310 for storing user data (e.g., user stationery/card preferences, configuration options, etc.), and an accounts database 350 for storing user account data. In one embodiment, the various databases shown in FIG. 3 are not actually separate databases but, rather, separate data structures (e.g., tables) within a relational database.

In one embodiment, the calendar database 310 stores calendar data for each user of the online stationery/greeting card service 200 and the calendar service 301 comprises executable program code for managing the calendar data (e.g., reading, adding, deleting, and modifying calendar entries). In one embodiment, the calendar service 301 also acts as an interface to the calendar data to other system modules 212, 302, 303, and 304 (e.g., by exposing a calendar data API).

The reminder service 302 generates graphical or audible reminders of upcoming calendar events and may prioritize the events based on a set of prioritization rules. In one embodiment, the calendar events are prioritized chronologically but some events are given relatively higher priority than other events based on the relationship between the user and the card/stationery recipients (e.g., the user's parents may be given a higher priority than the user's friends, notwithstanding the event dates). For example, an entry corresponding to Mother's Day may be prioritized at the top of the list even though other events (e.g., Labor Day) are nearer in time. In one embodiment, the highest prioritized event is either the next event created by the user (birthday, anniversary, other, etc) OR the next significant Holiday where “significant” holidays are identified in the online stationery/card system and may change over time. In one embodiment, the “significant” holidays are Mother's Day, Father's Day, and Christmas.

The recommendation engine with filtering logic 303 generates stationery/card recommendations to the end user based on the user's preferences and allows the user to filter the results according to user-specified filtering criteria. In one embodiment, the recommendations are categorized based on certain stationery/card characteristics and visually displayed to the end user in different categories (e.g., “new designs,” “with pictures,” etc). Moreover, in one embodiment, the recommendation engine 303 recommends stationery designs based on the preferences of the user and/or the preferences of the recipient (if known).

In one embodiment, the scheduling service 304 implements a scheduling algorithm to ensure that stationery/card orders are delivered within a specified delivery window and/or on a specific date. For example, the user may specify that a stationery/card order is to arrive 3-4 days prior to a recipient's birthday. In such a case, the user does not want the card to arrive to soon (e.g., 2 weeks prior to the birthday) or too late (after the birthday). To precisely schedule stationery/card orders, one embodiment of the scheduling service 304 evaluates the time required by the print services required to fulfill the order (e.g., thermography, digital press, etc.), the delivery type (e.g., regular mail, FedEx, etc), and the end user preferences.

In one embodiment, three data points are used to determine the delivery date: processing time, fulfillment time, and shipping transit time. The processing time may be based on the type of order. For example, processing time can be 0 days for greeting cards and several days for some stationery cards (e.g., those which require additional review by the online card/stationery service prior to fulfillment). The processing time is based on business days so it must factor in non-business days such as Holidays and Weekends to determine the number of calendar days required for processing. Fulfillment time is the number of days required to print, finish and ship/mail the order and is typically between 1-3 days (e.g., depending on the printing requirements). This time is based on business days for the fulfillment site which, in one embodiment, may be different than business days for the processing site. Shipping transit time is estimated based on the fulfillment site physical location and the shipping address of the recipient. The shipping transit time is based on business days for the shipping carrier and may be different than business days for the processing site and fulfillment site. In one embodiment, after computing the sum of the three data points, the system has the number of calendar days required for the order and determines the date that the order must be sent to the processing site in order to be delivered on the specified delivery date.

Presentation and session management logic 206 generates the Web-based graphical user interface (GUI) features described below, allowing the end user to view and edit the calendar data, contacts data, filtered card recommendations, and scheduling data. As illustrated in FIG. 3, the presentation and session management logic 206 communicates with each of the other functional modules and/or communicates directly with the stationery service databases 215 to retrieve the data needed for display within the GUI. Embodiments of the Web-based GUI features generated by the presentation and session management logic 206 are set forth below.

In one embodiment, each of the functional modules illustrated in FIG. 3 exposes an application programming interface (API) to provide access to data managed by that module. For example, the contacts manager 212 exposes an API allowing the calendar service 301 (and other modules) to access contacts data and vice versa. Alternatively, each of the functional modules may access the database(s) 215 directly.

In one embodiment, the calendar service 301 automatically generates calendar events based on the contacts data stored within the contacts database 210. By way of example, the calendar events may include birthdays, anniversaries, and other significant milestones associated with each of the contacts in the contacts database 210. In addition, the contacts manager 212 stores relationship data identifying the relationship between the user and each of the contacts in the user's contacts database 210 (e.g., identifying the user's spouse, siblings, parents, children, etc.). The calendar service 301 uses the relationship data to generate calendar events. For example, if the relationship data identifies the user's mother and father, then the calendar data may associate Mother's Day and Father's Day, respectively, with those contacts. Similarly, if the user is married with children the calendar service may associate his/her spouse with Mother's Day or Father's Day and/or the user's wedding anniversary.

Once calendar events are scheduled, in one embodiment, the reminder service 302 automatically generates reminders for upcoming events. For example, if a friend's birthday is approaching, then the reminder service 302 will notify the user a specified number of days/weeks ahead of time, so that the user has time to send a card. The specific timing of the reminder notifications may be specified by the end user and stored along with other user preferences within the user database 311.

In one embodiment, the reminders are generated and displayed within a Web-based GUI when the user logs in to the online stationery/card service 200 and/or may be sent to the user in the form of an email message or mobile text message. If sent in an email, links to the online stationery/card service website may be embedded within the message to encourage the user to design a new card.

In one embodiment, the recommendation engine 303 generates greeting card/stationery recommendations based on the occasion, the identity of the contact associated with the occasion, and the end user's preferences. For example, if a particular contact's birthday is approaching, the recommendation engine 303 may recommend certain greeting card styles (e.g., modern, classical, etc.) based on the contact's preferences and/or the user's preferences. The filtering logic allows the recommendations to be filtered based on specified variables (e.g., theme, color, card format, card size, number of photos, etc.).

In summary, among the features offered by the online stationery service 100 is the ability to design stationery for a particular event (e.g., wedding, anniversary party, etc). The stationery design may include the design of RSVP response cards which allow invitees to specify whether they will be attending the event. In one embodiment, the online stationery service 100 prints and mails the stationery with the RSVP response cards on behalf of the end user.

### Embodiments of an RSVP System and Method for an Online Stationery of Greeting Card Service

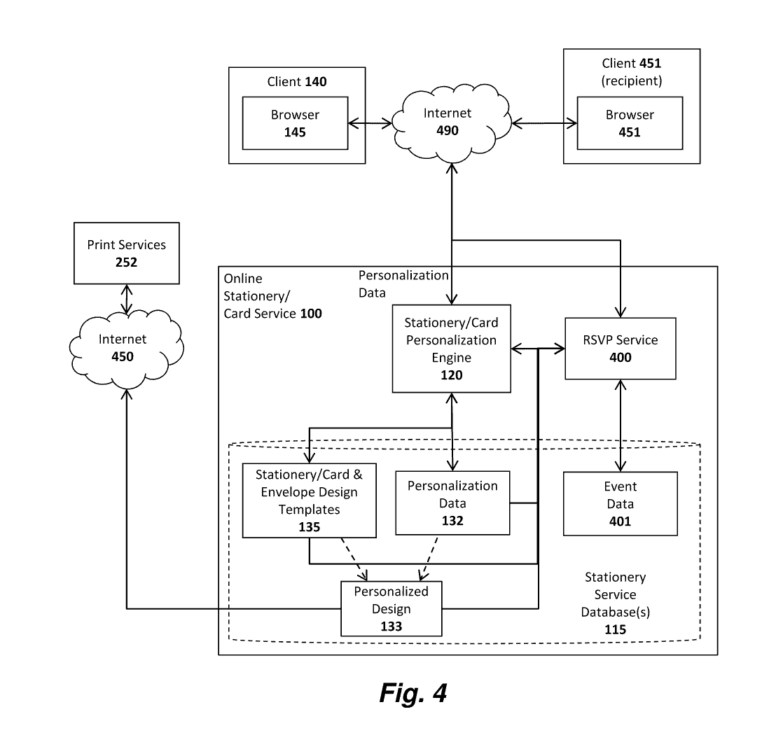

FIG. 4 illustrates an RSVP service 400 which, in one embodiment, provides the ability of an end user to manage a guest list for an event, manage and organize RSVP responses from invitees, communicate to the invitees before the event (e.g., to let them know of changes), and communicate to the guests after the event (e.g., via thank you cards/email, sharing photos, etc). In addition, one embodiment of the RSVP service 400 provides invitees the ability to respond electronically to RSVP requests (e.g., by entering a specified network address such as a URL in a Web browser), thereby simplifying the RSVP process. In addition, one embodiment of the RSVP service 400 allows invitees to retrieve and upload information and other content related to the event (e.g., pictures, videos) before, during, and after the event.

As illustrated, the RSVP service 400 may be executed within the online stationery/card/photo service 100 (hereinafter simply “stationery service 100”) which, in one embodiment, includes all of the features of the stationery service 100 described above (and in the co-pending patent applications). By way of example, the stationery service 100 may include a stationery personalization engine 120 for allowing an end user to select a particular stationery/card design template 135 and add personalization data 123 (e.g., photos, messages, colors, etc), resulting in a personalized stationery/card design 133. In the present application, the stationery/card personalization engine 120 may allow a user to design a stationery or card for a particular event such as a wedding, anniversary party, or birthday party. However, the underlying principles of the invention are not limited to any particular type of event. As described in the co-pending applications, the personalized stationery/card design 133 may be transmitted to a print service 252 for printing (e.g., over the Internet 450) and may be mailed directly from the print service 252 to recipients identified by the end user.

In one embodiment of the invention, a user may choose to utilize the RSVP service 400 described herein as part of the invitation ordering process. If the RSVP service 400 is selected, then invitees such as client 541 may connect to the online stationery service 100 using a Web browser 451 to submit their RSVP responses. The RSVP responses and other data related to the event 401 may be stored within the stationery service databases 115 and made accessible to the user (e.g., via web browser 145 of client 150) and/or to the invitees, as described below.

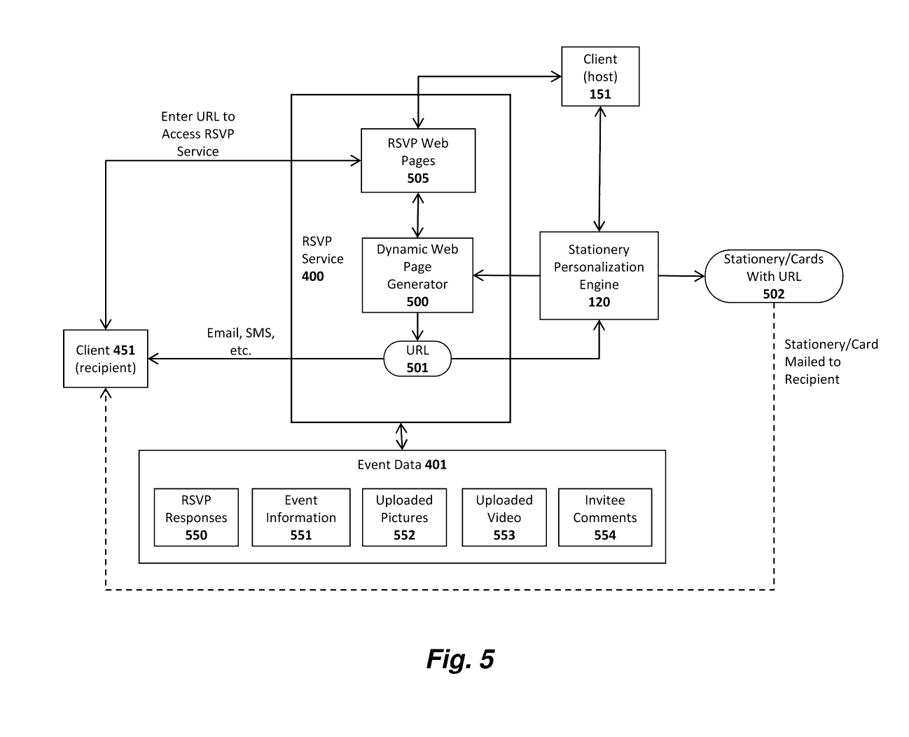

As illustrated in FIG. 5, one embodiment of the RSVP service 400 includes a Web page generation module 400 for dynamically generating a series of RSVP Web pages 505 in response to the user selecting the RSVP option mentioned above. The series of Web pages are sometimes referred to herein as the “RSVP Website 505.” In one embodiment, the URL 501 linking to the RSVP Website 505 is dynamically generated and printed on the paper stationery/card invitations 502 mailed to invitees. In addition, the URL 501 may be emailed directly to the invitees 451. In one embodiment, the URL 501 is printed with alphanumeric characters on the back of the stationery/card along with a QR code or other bar code format which may be scanned to link to the RSVP website. For example, a user may take a picture of the QR code with a mobile device 451 and a browser application (or other application) on the user's mobile device may interpret the QR code to link to the RSVP website. In one embodiment, the QR code and/or the URL may be shortened versions of the real URL and, upon selecting the shortened version, the user's web browser may be redirected by the online stationery service 100 to the actual URL of the RSVP Website 505.

Regardless of how the invitees 451 link to the Web pages 505, in one embodiment, once connected, the invitees can access and modify various different types of event data. For example, the invitees may enter an RSVP response 550, review event information 551 (e.g., date, time and location; ticket information, etc), upload pictures 552 and video 553 related to the event (e.g., either during or after the event), and submit comments or other text related to the event 554. The event host 151 may access the same underlying event data 401 and may be provided with the ability to modify the event data as described below.

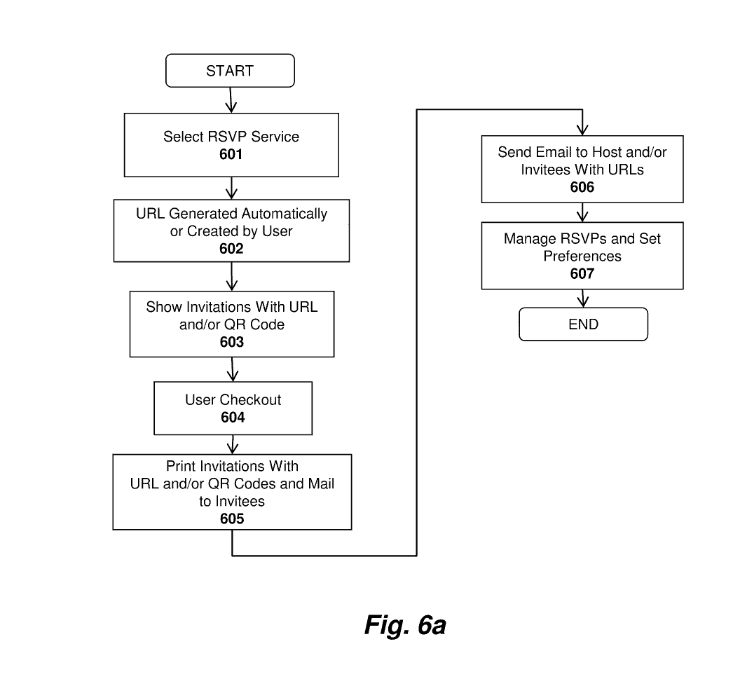

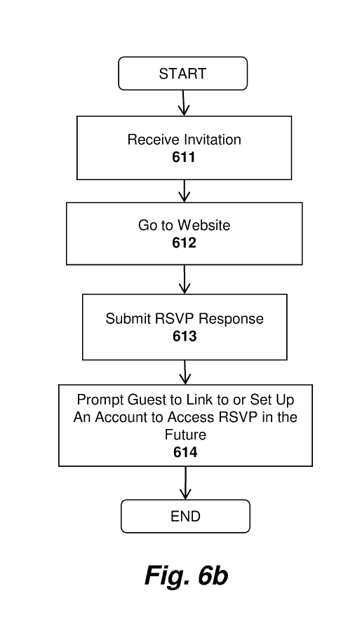

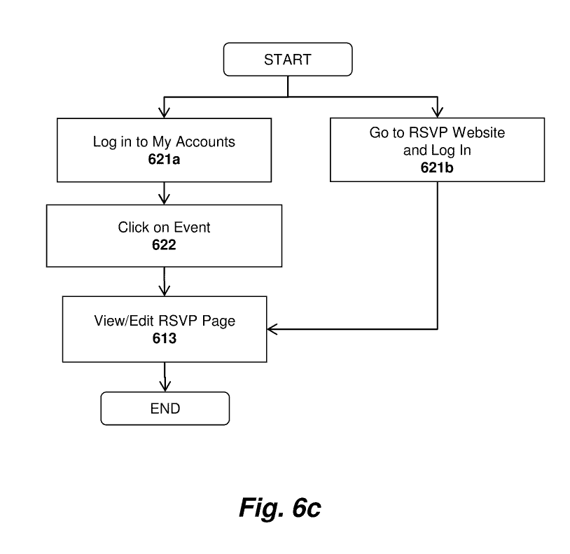

FIG. 6a illustrates one embodiment of method implemented by the RSVP service 400 from the perspective of the event host. At 601 the host selects the RSVP service option (e.g., at checkout or after personalizing a stationery/card design). At 602, a URL is automatically generated for the RSVP website and/or is manually created by the user. For example, the user may specify a unique URL which includes alphanumeric characters related to the event (e.g., Merediths40thbirthday.com). At 603, the invitation is visually displayed for the host with the URL and/or QR code (or other type of code). In one embodiment, the host may be provided with the option to edit and/or remove URL and/or QR code from the invitation. At 604, the host checks out, placing the invitation order. At 605, the print service prints the invitations with the URLs and/or QR codes and mails the invitations to the invitees. At 606, an email or other electronic message (e.g., an SMS) containing the URL may be sent to the host and/or some of the invitees. At 607, the host may connect to the RSVP website to manage the RSVPs and/or set preferences for the RSVP website (as described below).

FIG. 6b illustrates one embodiment of a method from the perspective of an invitee who does not have an account on the online stationery service 100. At 611, the invitee receives the invitation and, at 612, the invitee uses the URL and/or QR code to connect to the RSVP website. At 613, the invitee submits his/her RSVP response and, at 614, the invitee is prompted to link to the website or to set up an account in order to access the RSVP website in the future. In one embodiment, the user simply enters an email address and password to establish an account on the online stationery/card service 100.

FIG. 6c illustrates one embodiment of a method from the perspective of an invitee who has an account on the online stationery service 100. At 621a, the invitee logs into his/her account on the online stationery service 100 (e.g., by linking to the online stationery service 100 home page). Once the invitee has been invited by the host (e.g., if the host and invitee are linked as friends or if the host knows the invitee's email address, or account information on the online stationery service), then the invitee's home page may contain a link to the event. As such, at 622, the user clicks on the event link and, at 613, views and/or edits the RSVP page (e.g., by submitting an RSVP response). At 621b, rather than linking initially to the invitee's home page, the invitee may go directly to the RSVP website using the URL and/or QR code described above (e.g., from the paper invitation and/or email message sent to the invitee).

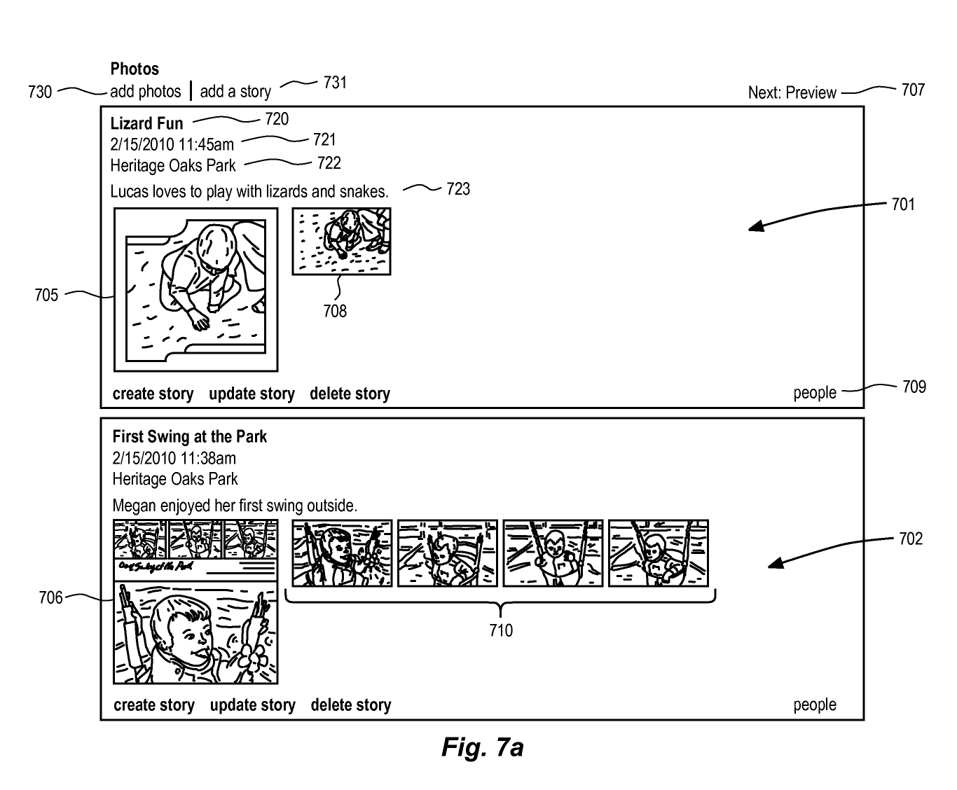

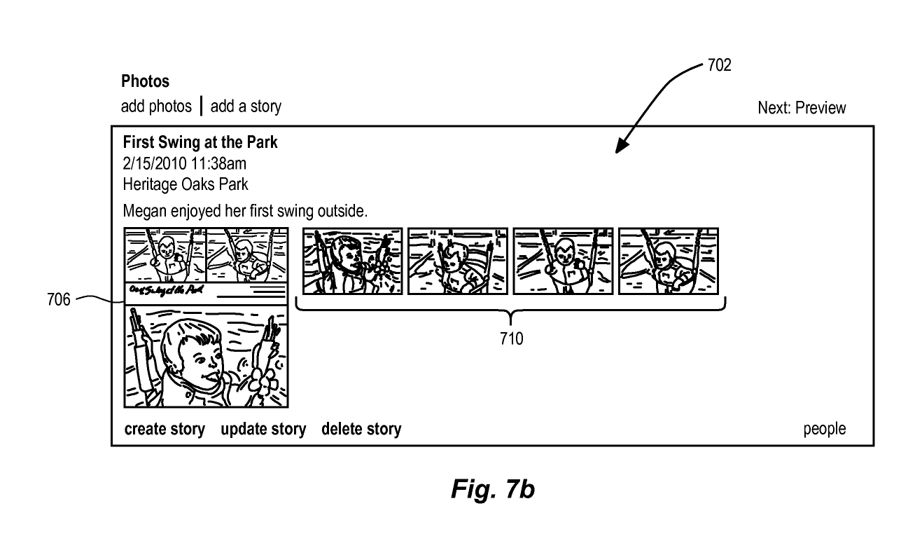

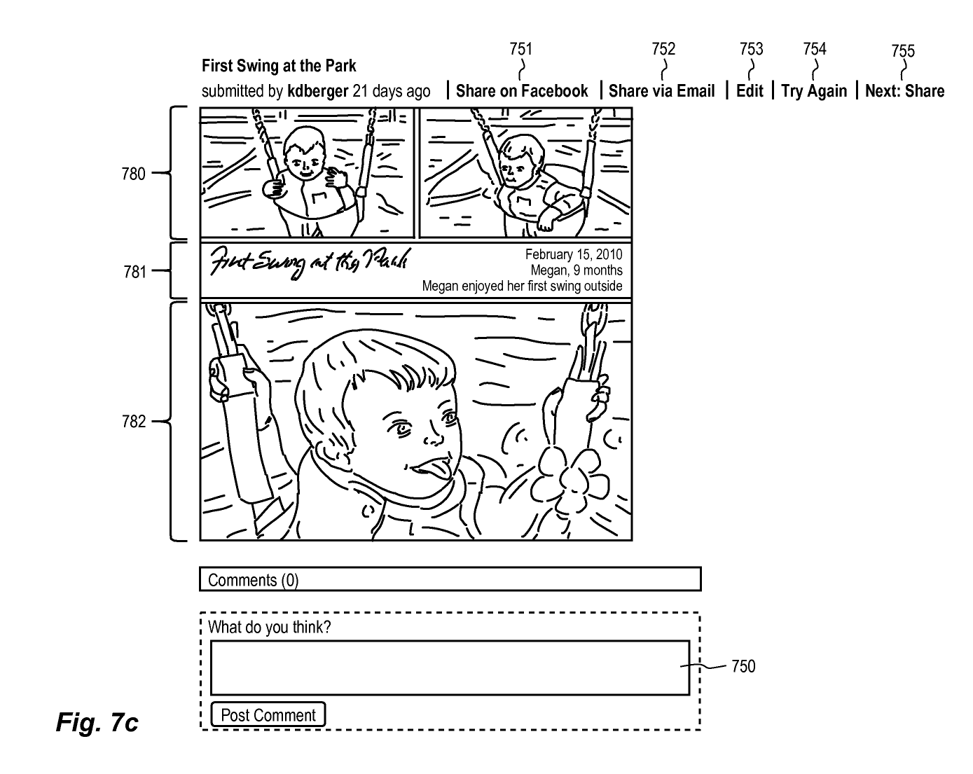

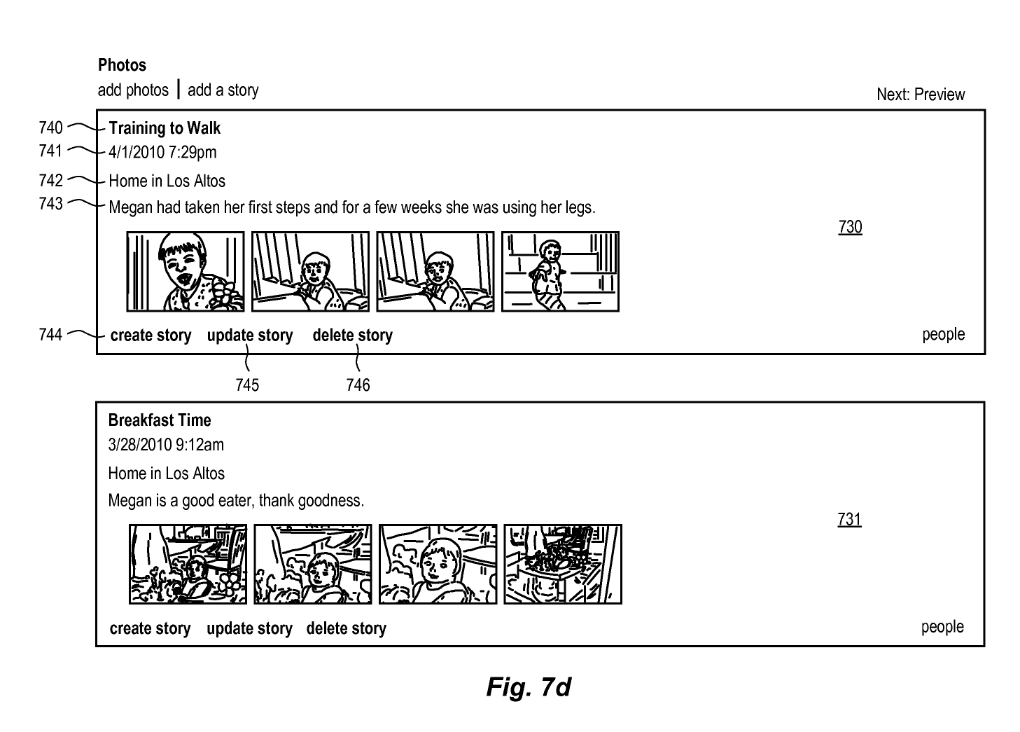

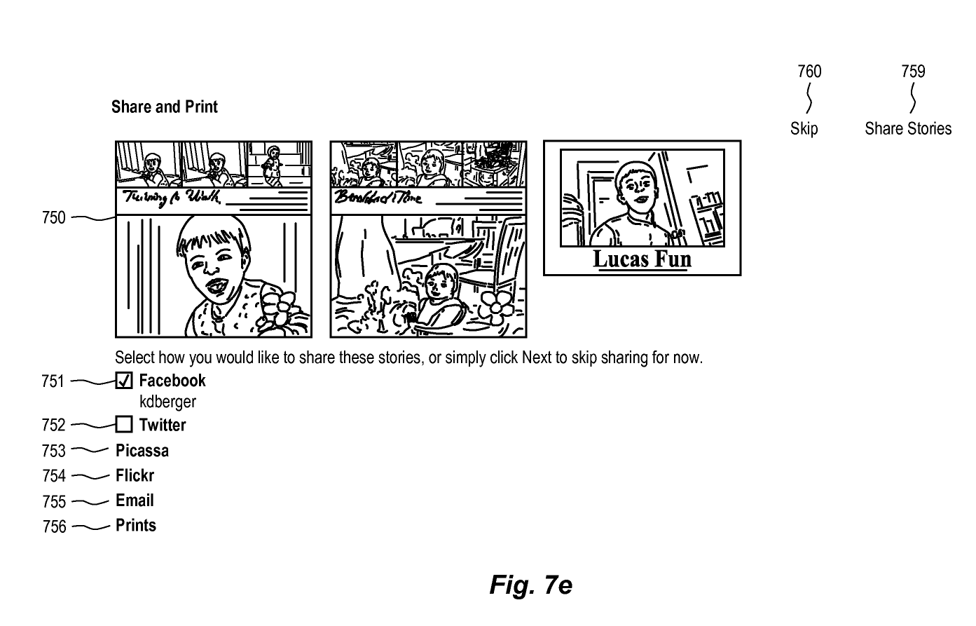

Various graphical user interface (GUI) embodiments illustrating Web pages used within the RSVP website will now be described starting with FIG. 7. As shown in FIG. 7, the option to use the RSVP service may be provided as a selectable option 701 from the order page for a particular stationery/card design 702. In this particular example, a check box is used. However, the underlying principles of the invention are not limited to any particular selection graphic. Upon selecting the RSVP service, the various techniques for managing RSVPs and other event-related data may be employed. In one embodiment, the RSVP service 400 is provided as a free add-on service to the stationery/card order.

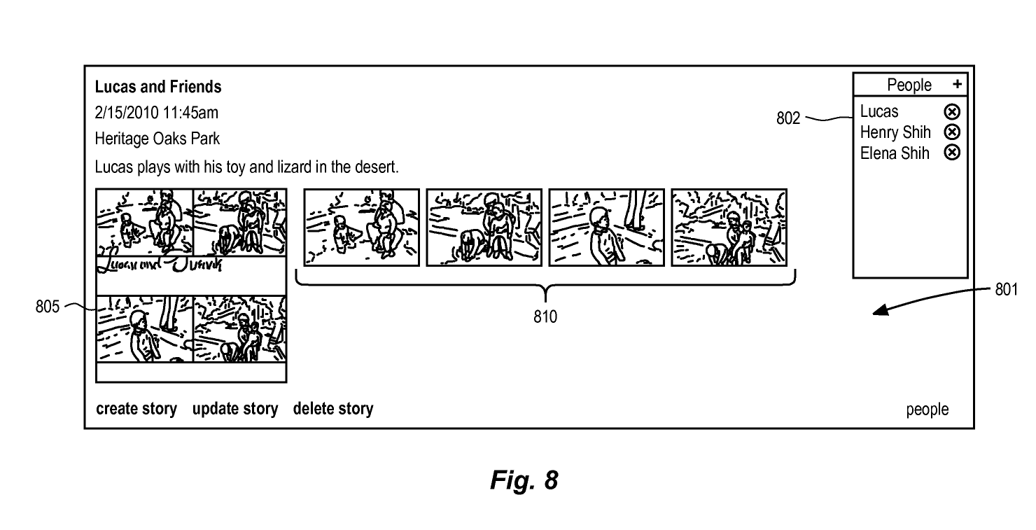

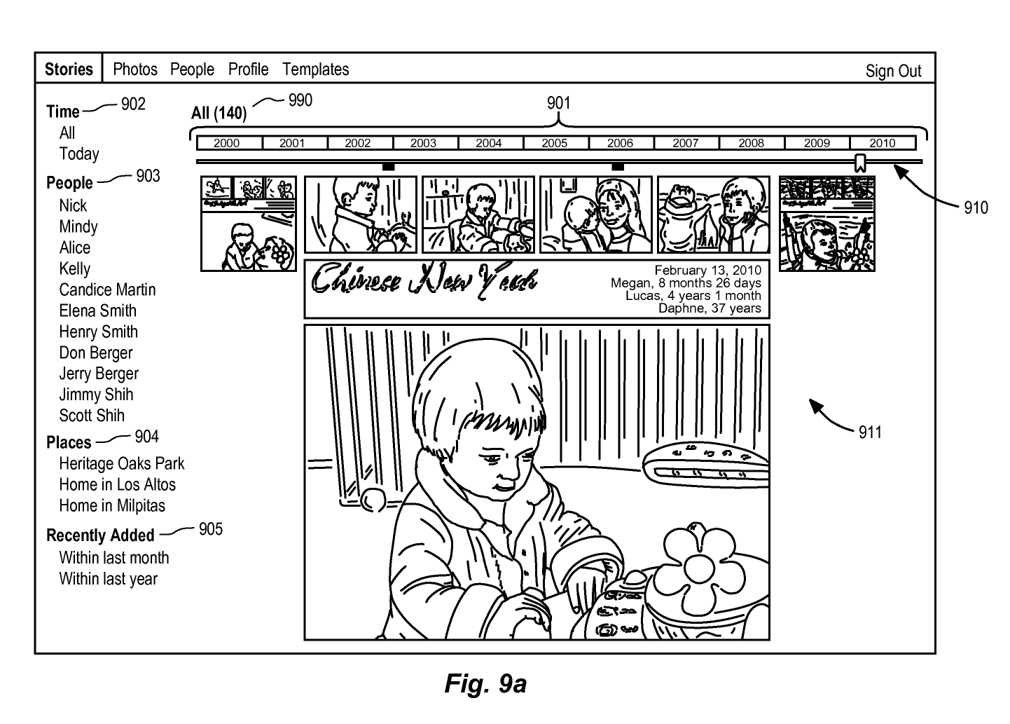

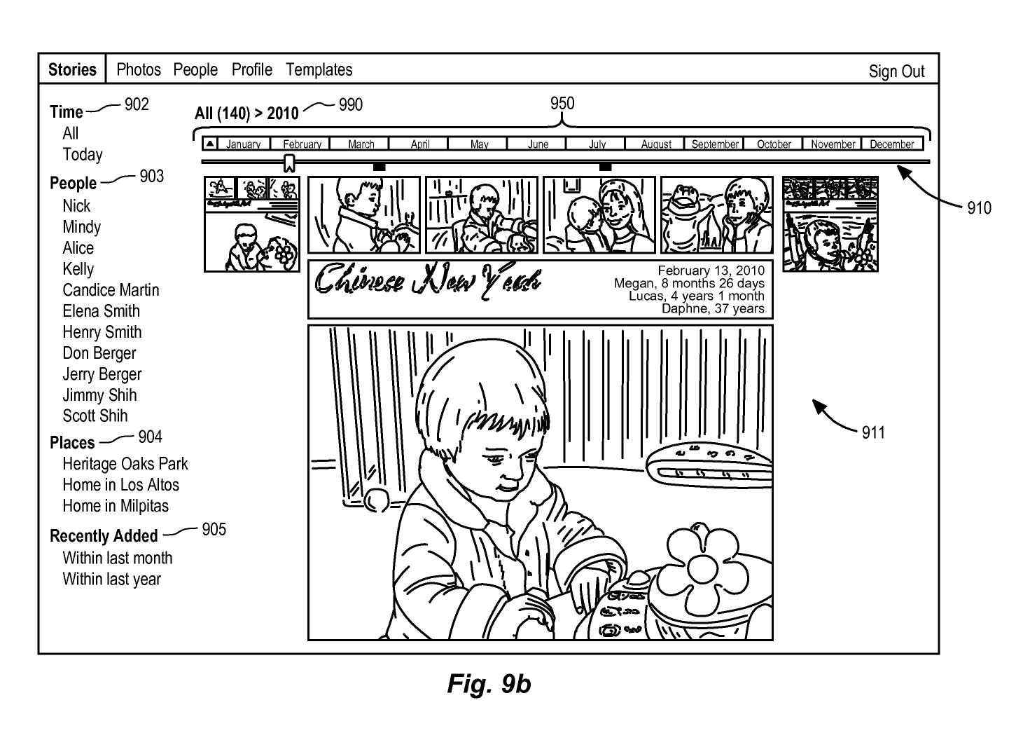

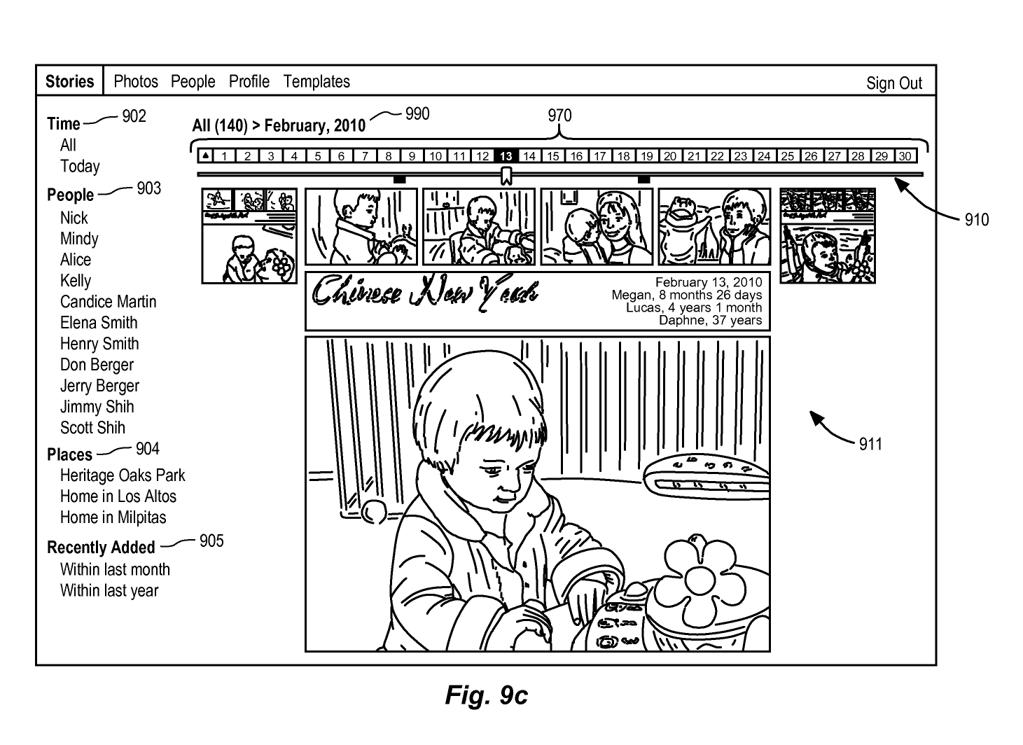

As illustrated in FIG. 8, upon selecting the RSVP service and placing a stationery/card order, the host is provided with a link 801 to the RSVP website and a link 802 to the management pages for the RSVP website (both of which are described below). In one embodiment, the first time the host selects the link 802 to the management pages, the host may be asked to confirm that the details associated with the event are accurate. Following confirmation, the user is taken to the Web pages as shown in FIGS. 9-11.

As illustrated in FIG. 9, in one embodiment, the management pages for the RSVP website include a set of tabs: a first tab 990 for setting preferences, a second tab 991 for viewing and editing event details and a third tab 992 for viewing guest information. In FIG. 9, the preferences tab has been selected, thereby exposing a set of preferences including the site owner name 901 and a link 902 to add another site owner. In one embodiment, the host is the default site owner and may add one or more additional site owners.

The preferences window also includes an option 903 to remind all guests a specified number of days prior to the event (e.g., 7 days) and an option 904 to remind guests who RSVPed “Yes” and “Undecided” another specified number of days prior to the event (e.g., one day).

At 905, the user may configure the RSVP service 400 to email the host updates every specified number of days until the event. A drop-down menu is provided to allow the host to set the number of days between email messages. In one embodiment, the emails may include a URL to the RSVP website to facilitate connecting to the website. Another selectable option 906 instructs the RSVP service to email the host each time an RSVP response is submitted by an invitee. In one embodiment, the email contains text indicating the RSVP response (e.g., “User X Will Attend”).

At 907, the host may indicate that invitees should be required to answer a question about the host prior to entering the RSVP website (for privacy/security reasons). In one embodiment, the question and the answer (or set of answers) may be specified by the host (e.g., what college did the host attend?, how many siblings does the host have?, etc.).

At 908-914, the host may specify settings for the invitees (e.g., by selecting check boxes next to the appropriate selection element). Specifically, at 908, the host may specify that invitees are permitted to view the RSVPs of other invitees. At 909, the host may indicate that invitees are permitted to view comments from other invitees. For example, as described below, each invitee may provide a comment when submitting an RSVP response (and after submitting the response). At 910, the host may specify that the invitees are permitted to reply to comments of other invitees. At 911, the host may indicate that invitees may send messages (e.g., instant messages, email, etc) directly to other guests and, at 912, the host may specify that invitees may forward invitations to other invitees. In one embodiment, the invitations may be sent electronically (e.g., via email) and may contain the URL to the RSVP website.

At 913, a drop-down menu is provided for the host to select the number of friends that the invitees may bring. In one embodiment, the values include “unlimited,” “none” and any number of friends. At 914, the host may specify a maximum number of guests which may attend the event. When the maximum has been reached, the RSVP service may notify the host and/or may refuse to accept any new RSVP responses.

In one embodiment, a “see what your guests will see” 960 link is provided to allow the host to view the RSVP website 505 from the perspective of an invitee. In one embodiment, certain types of data such as private messages to the host and notes made by the host are filtered out from the invitee views.

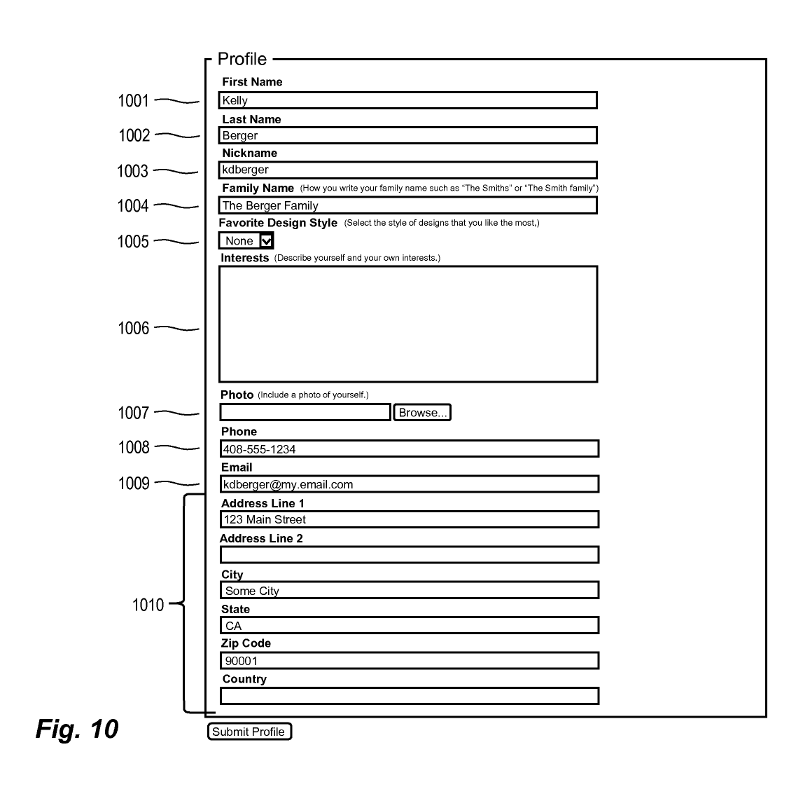

As illustrated in FIG. 10, the event details tab shows the current details for the event as previously entered by the host. In one embodiment, the event details include the URL to the event RSVP website, the host name, the date and location of the event, and the RSVP deadline. The host may also choose an “RSVP to” name (if different from the host) and may enter a message to all guests. A button 1002 is provided to enable the host to edit any of the event details. In addition, a link 1003 is provided to allow the host to specify a gift registry and/or a charitable donation link (e.g., a link to a website managing the registry/charity). An “order more invitations” link is provided as shown to enable the host to order additional invitations and specify additional invitees. The event details page may also include a map showing the location of the event (not shown) with an option to retrieve directions.

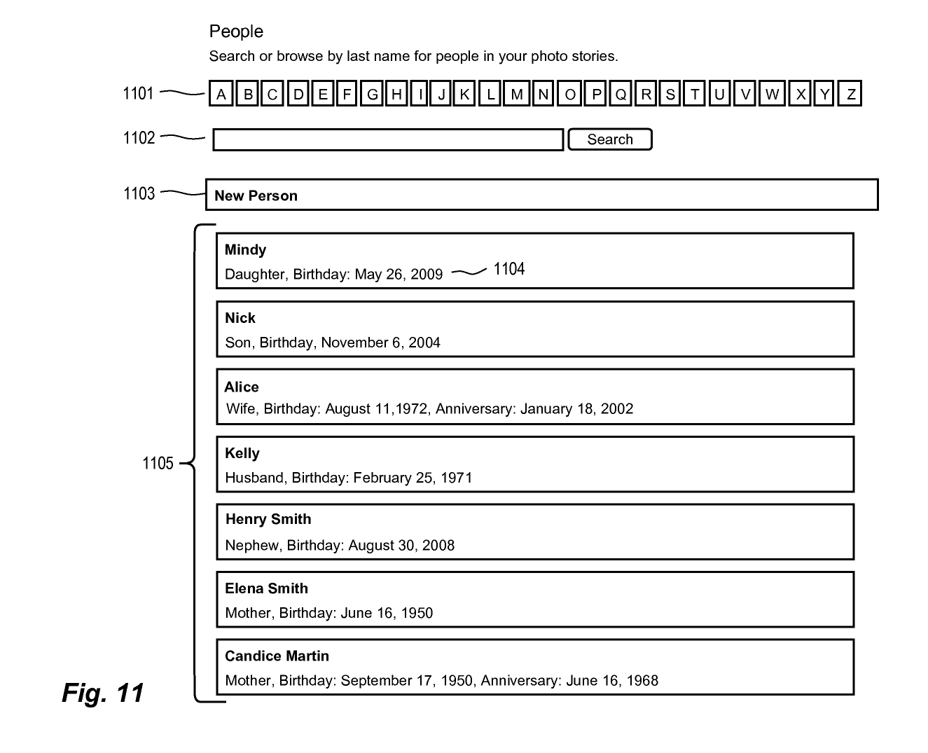

As illustrated in FIG. 11, the guests tab shows the current details associated with invitee responses. A guest overview region 1102 provides an overview of the number of responses, the number of outstanding invitations (for which responses have not been received), and the results of the responses (e.g., current number of guests who will attend). A response feed region 1101 provides a listing of those guests who will attend along with the comments provided by those guests (e.g., “I'd love to come”). Depending on the configuration options specified in the preferences tab, the response feed may be viewable by all invitees.

At guest list region 1103 provides a listing of each invitee and includes the invitee's response (e.g., “Will Attend,” “Will Not Attend,” “Undecided,” or “Not Responded”). Each entry may also include a private message for the host which, in one embodiment, is not viewable by other invitees and the total number of guests who will attend. Additionally, a data entry field is provided so that the host can enter notes related to the guest (e.g., guest X is a vegetarian). One particular use of the data entry field is that after the event, the end user may type in gifts purchased by each guest which can serve as a reminder when sending thank you cards.

In one embodiment, a “send card” link is provided for each entry in the guest list. Selecting the “send card” link may trigger the stationery/card personalization engine 120 to create a card for the selected guest. In one embodiment, if the guest is identified on the online stationery/card service 100 (e.g., if the guest has an account), then card designs may be recommended based on the guest's preferences (and/or the hosts preferences) as described in the co-pending applications.

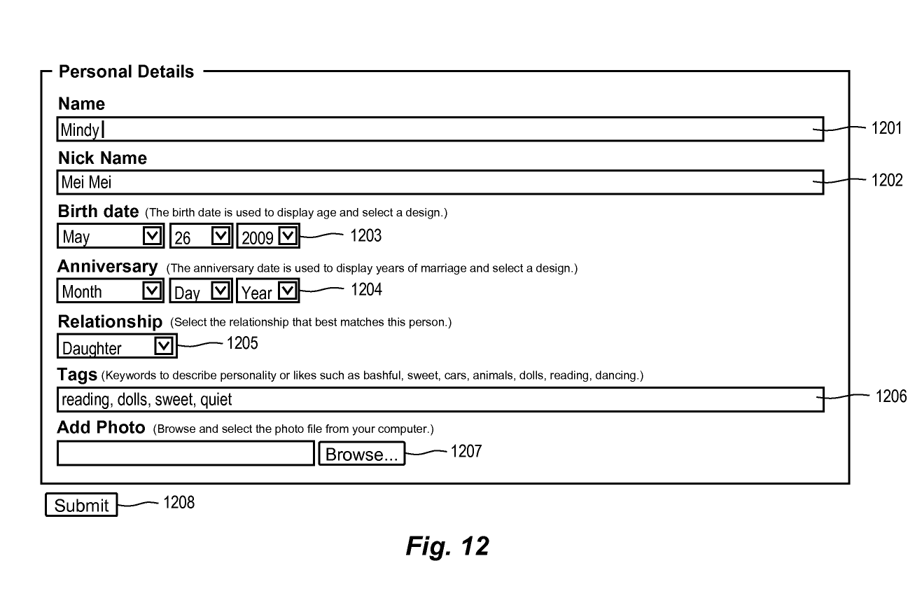

An “add guests” link 1104 is provided to allow the host to manually add guests to the guest list (e.g., for those guests who respond verbally or via mail). In one embodiment, a window such as that shown in FIG. 12 is generated in response to selection of the “add guests” link 1104. Data entry fields 1201 and 1202 are provided for entering the guest's name and email address and radio buttons 1204 are provided for specifying whether the guest will attend, will not attend or is undecided. The total number of guests associated with the invitee may be specified via a drop-down menu 1203. Public comments may be entered within a first data entry region 1205 (i.e., comments which may be viewed by other invitees) and notes related to the guest (e.g., guest X is a vegetarian) which are only viewable by the host may be entered in a second data entry region 1206.

In one embodiment, the same (or similar) window as that shown in FIG. 12 is generated when invitees select the URL or scan the QR code printed on an invitation. The invitee in this case may specify all relevant information such as his/her name, email address, number of guests and whether or not the invitee will attend. In one embodiment, the name field may be a drop-down menu from which the invitee may select his/her name (i.e., the menu having been previously populated with invitee names from the user's stationery order). In one embodiment, the host may specify a certain maximum number of guests for each invitee. In such a case, up to the maximum number may be selected by the invitee under “total number of guests.” In another embodiment, upon selecting more than one under the total number of guests, additional data entry fields may be generated to allow the invitee to enter the names of those additional guests. The invitee may enter public comments within data entry field 1205 and may enter private messages to the host within data entry region 1206. The public comments may subsequently be displayed within the response feed region 1101 shown in FIG. 11 and the private messages may be displayed within the guest list entries 1103 shown in FIG. 11. In one embodiment, upon entering all of the required information, the guest will be taken to the RSVP website where they can view event information 551, responses 550 of other invitees, uploaded pictures 552 and video 553 from the event and invitee comments 554. For example, in one embodiment, invites are provided access to the guest overview information 1102 and the response feed 1101 shown in FIG. 11. Additional regions (not shown) may be provided in the GUI shown in FIG. 11 for uploading and viewing photos and videos. Invitees may also be provided the option to change their RSVP response (e.g., from “will not attend” to “will attend”).

In one embodiment, a “sign in” link is provided within the window shown in FIG. 11 to allow the invitee to sign in to the online stationery/card service if he/she has an account or to create a new account of he/she does not have an account. Alternatively, the invitee may choose to bypass the account setup and proceed without an account. In one embodiment, signing in will automatically populate the Name and Email fields with the invitee's information. If the user has not created an account on the stationery/card service 100 an email may be sent to the invitee containing another URL for changing the RSVP response.

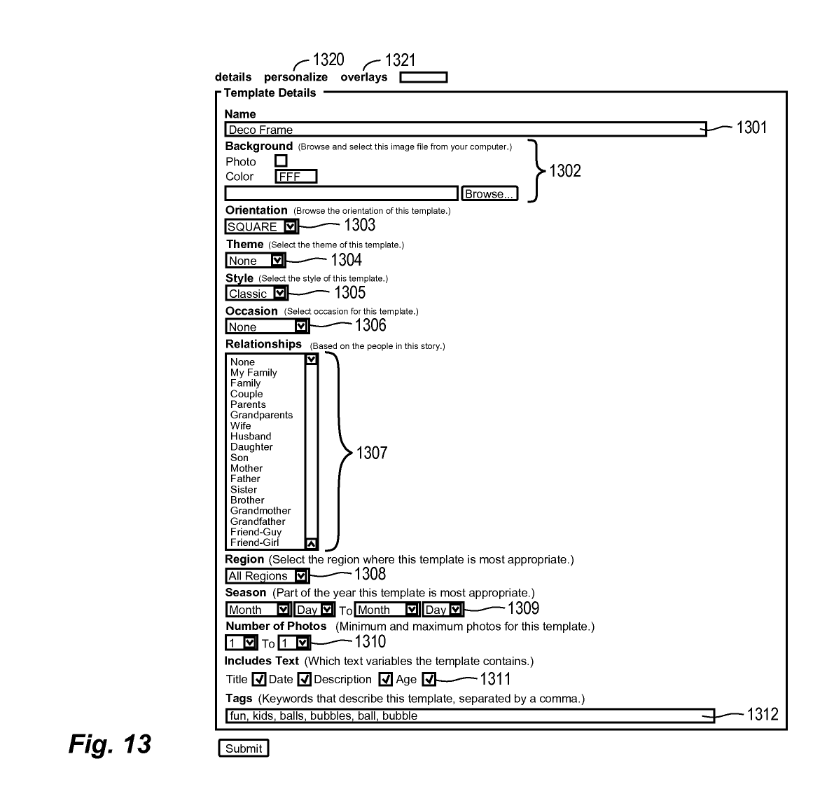

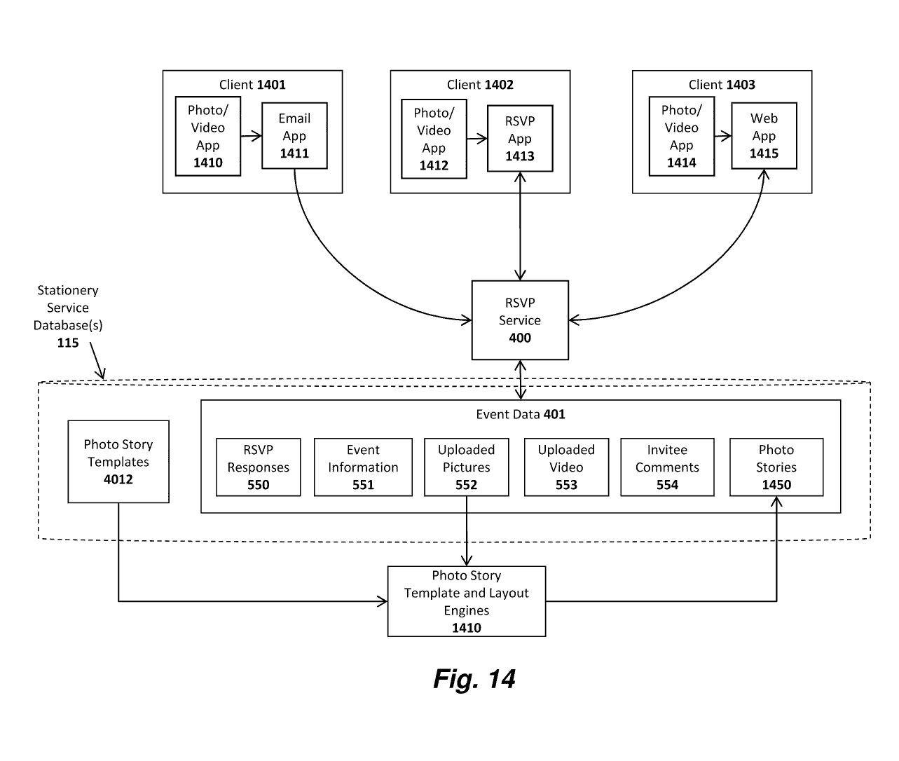

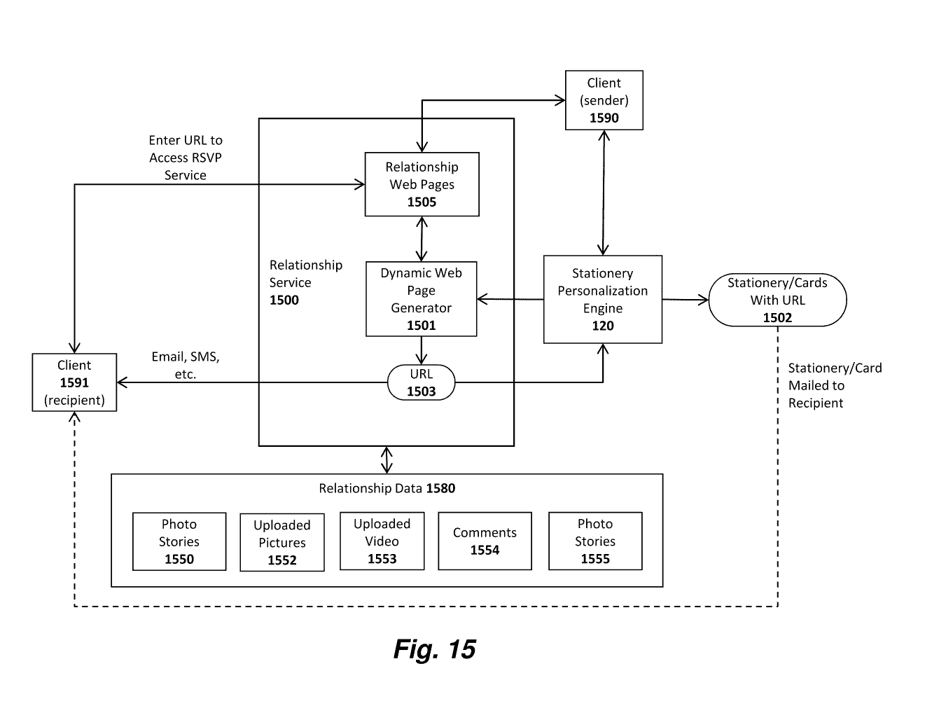

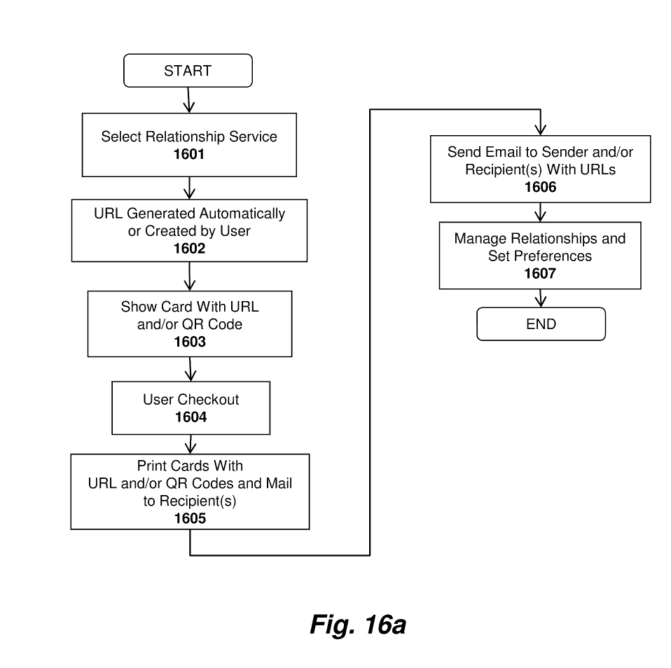

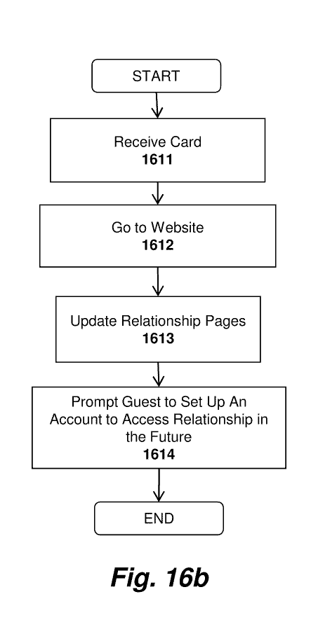

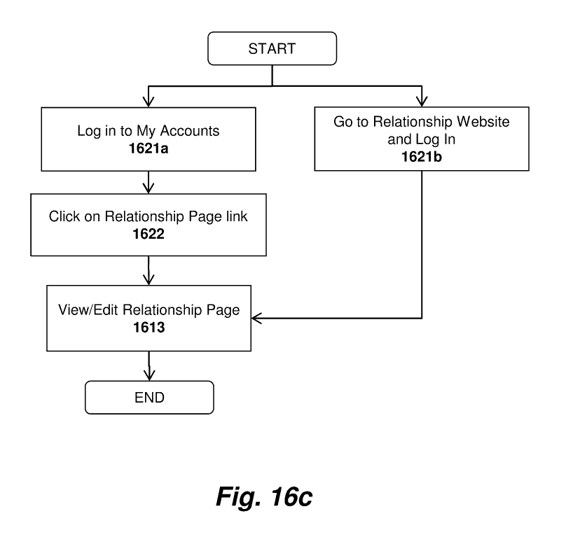

FIG. 13 illustrates one embodiment of a window which is generated in response to selection of the “invite more guests” button 1105 shown in FIG. 11. The host may specify the invitee's email address in data entry field 1301 and may enter a message to the invitee in data entry field 1302. Selecting the invite guests button will then cause the RSVP service 400 to send an email to the invitee containing the URL to the RSVP website. In one embodiment, a link 1303 is provided to allow the user to send a paper invitation to the new invitees.

As illustrated in FIGS. 9 and 10, in one embodiment, to generate the RSVP web pages 505, the RSVP service 400 will pull in objects from the stationery/card design templates 135 including the personalization options 132 selected by the host when designing the invitation. In a simple case, such as that shown in FIGS. 9-10, a graphical design 950 from the front of the invitation is reproduced within a specified region of the RSVP website. In some embodiments, the RSVP service 400 may utilize individual graphical objects from the stationery design such as the bowling pin or bowling ball shown in the graphical design 950 and spread the graphical objects around the RSVP web pages.

In one embodiment, the event data 401 includes seating data for the event which the host may view and edit. For example, if the event is a wedding, the seating data may include a graphical representation of the table layout within the venue and an indication of the invitees associated with each table. The invitees may view the seating data and submit seating requests via the personal message field 1206 (for sending a personal message to the host as described above). Alternatively, a separate “seating” field (not shown) may be provided for each of the invitees to submit requests.

As mentioned above, in one embodiment, users may upload photos, videos, comments and other data to the RSVP website before, during, and after the event, thereby turning the RSVP website into a social network site for the event. As illustrated in FIG. 14, the event data 401 may be provided to the RSVP service 400 using a variety of communication channels. For example, each of the clients 1401-1403 shown in FIG. 14 may be mobile devices (e.g., iPhones, RIM blackberries, etc) and may utilize different applications 1411, 1413, 1415 for communicating with the RSVP service 400. For example, in one embodiment, an email address is established by the RSVP service for receiving photos, videos, and comments related to the event. The email address may be provided to invitees as part of the invitation process discussed above (e.g., emailed to invitees or printed on the invitations). Thus, if a mobile client 1401 captures photos at the event (e.g., using camera application 1410) and sends those photos to the designated email address (using email application 1411), the email will be received by the RSVP service 400 which will then extract the photos from the email and automatically post the photos on the RSVP website.

In addition, an RSVP application 1413 designed by the online stationery/card service 100 may be installed on certain mobile clients 1402. The RSVP application 1413 in one embodiment will maintain a continuous or periodic communication connection with the RSVP service 400 and may prompt the user periodically to capture photos and/or video using the photo application 1412. In response, the RSVP application 1413 may upload the captured photos and/or video to the RSVP service 400 which then adds the photos to the event data 401.

Finally, some mobile clients 1403 may utilize a Web application such as a Web browser or browser applet to connection to the RSVP service 400 and upload photos and video captured by photo/video applications 1414.

In one embodiment geo-location techniques may be used to identify the location at which photos are taken and the time/date on which the photos were taken. In one embodiment, any photos taken at the location of the event at the specified date/time of the event will be identified by the online stationery/card service 100 and added to the event data 401. Thus, any users with accounts on the online stationery/photo service 100 may simply upload photos to be included within the event data 401.

In addition, in one embodiment, photo stories 1450 may be automatically created by photo story template and layout engines 1410 executed by the online stationery service 100. Embodiments of the photo story template and layout engines 1410 are described in the co-pending application entitled A GRAPHICAL USER INTERFACE AND METHOD FOR CREATING AND MANAGING PHOTO STORIES, Serial No. ______, Filed ______, (hereinafter “Photo Story Application”) which is assigned to the assignee of the present application and which is incorporated herein by reference. Briefly, based on the content of the photos (e.g., the subjects in the photos, the time the photos were taken, the number of photos, etc), the photo story template and layout engines 1410 will select appropriate photo story templates 4012 and create photo stories 1450 which may then be shared by the host and the invitees. By way of example, a photo story may be created to include photos of a certain invitee at a certain time period during the event in response to a request by the host or by an invitee. Various techniques for filtering photos for photo stories are described in the co-pending application above.

In one embodiment, the techniques for dynamically generating a web page and URL may be applied outside of the RSVP context mentioned above. In particular, in one embodiment, the online stationery service 100 dynamically creates new web pages based on any combination of sender(s), recipient(s), and/or events. In one embodiment, for each new card sent by a sender to a recipient for a particular event, a new URL and QR code will be generated and a new series of web pages can be generated to represent the event. For example, when a sender sends a recipient a greeting card, a web page may automatically be generated for the sender and recipient to share and the card may be printed with the URL and/or QR code allowing the recipient to navigate to the web page. Both the sender and recipient may then upload photos, videos and post comments to the relationship web page.

FIG. 15 illustrates one embodiment which includes a relationship service 1500 for managing relationships between two or more users. As with the RSVP/event embodiments described above, one embodiment of the relationship service 1500 includes a web page generator 1501 for generating a relationship website 1505 in response to a sender 1590 sending a card to a recipient 1591. In one embodiment, the web page generator dynamically generates a URL 1503 which may be printed on the stationery/card sent to the recipient (e.g., with a QR code as described above). Various types of relationship data 1580 may be shared as described above including photo stories 1550, pictures 1552, video 1553 and comments 1554.

Each new card sent between the sender and recipient may be dynamically added to the website 1505, along with each new picture, video and comment. In one embodiment, the web page generator 1501 automatically creates a graphical timeline with different entries on the timeline selectable by the sender and recipient to view photos, cards, comments, etc, associated with those entries. By way of example, the timeline may include a hierarchy in which the timeline initially includes a series of years. Once a user clicks on a year, a timeline of months for that year will be generated; when a user clicks on a month, a timeline of days within the selected month may be generated; and when a user clicks on a particular day, the content associated with that day may be displayed. These and other techniques for graphically displaying data within a timeline are described in the Photo Story Application which is incorporated herein by reference. In addition, photo stories 1555 may be generated on the relationship website 1591 with the other relationship data 1580. In one embodiment, the photo stories 1555 may include photos of the sender and recipient (or the group of users for whom the relationship website 1505 is generated).

FIGS. 16a-c illustrate methods which may be implemented within the context of the relationship service shown in FIG. 15. At 1601, the sender of a card chooses to use the relationship service (e.g., by selecting a check box as described above). The relationship service may be offered as a free service to those with accounts on the online stationery/card service 100. At 1602, the dynamic web page generator 1501 automatically generates a URL or the URL is specified by the sender. At 1603, the card is displayed for the sender with the URL and/or the QR code graphically representing the URL. At 1604, the sender checks out and, at 1605, the card is printed with the URL and/or QR code and mailed to the recipient(s). At 1606, an email or other electronic message (e.g., an SMS) containing the URL may be sent to the sender and/or some of the recipients. At 1607, the sender may connect to the relationship website to manage the relationship pages and/or set preferences for the relationship website (as described herein).

FIG. 16b illustrates one embodiment of a method from the perspective of a recipient who does not have an account on the online stationery/card service 100. At 1611, the recipient receives the card and, at 1612, the recipient uses the URL and/or QR code to connect to the relationship website. At 1613, the recipient updates the relationship website, for example, by uploading pictures or posting comments. At 1614, the recipient is prompted to set up an account in order to access the relationship website in the future. In one embodiment, the recipient simply enters an email address and password to establish an account on the online stationery/card service 100.

FIG. 16c illustrates one embodiment of a method from the perspective of a recipient who has an account on the online stationery service 100. At 1621a, the recipient logs into his/her account on the online stationery service 100 (e.g., by linking to the online stationery service 100 home page). Once the recipient has been sent a card by the sender (e.g., if the sender and recipient are linked as friends or if the sender knows the recipient's email address, or account information on the online stationery service), then the recipient's home page may contain a link to the relationship page. As such, at 1622, the recipient clicks on the relationship page link and, at 1613, views and/or edits the relationship page (e.g., by uploading photos or submitting comments). At 1621b, rather than linking initially to the recipient's home page, the recipient may go directly to the relationship website using the URL and/or QR code described above (e.g., from the paper stationery/greeting card and/or email message sent to the recipient).

In one embodiment, the RSVP Website 505 includes a display area with a selection of recommended greeting cards intended for the invitees to send the host or honoree of the event. The recommended cards are chosen by the RSVP service based on the occasion of the event (birthday party, anniversary party, baby shower, etc.), the stationery design chosen for the event, the personal information and design preferences of the host and/or invitee, and/or the greeting cards previously ordered for this event by other invitees. For example, for a birthday party for a four year old where the invitation design has a monkey theme, the recommended cards selection would be birthday cards for a four year old with a monkey or jungle or animal theme. If invitee A purchases a particular greeting card design for the event, invitee B would not be shown the same greeting card design, thereby avoiding duplication of cards from two or more different invitees.

In one embodiment, the Web server used to implement the embodiments of the invention is an Apache web server running on Linux with software programmed in PHP using a MySQL database. In addition, the platform may employ various techniques for establishing communication with clients and other services. For example, one embodiment of the online stationery service 100 exposes an application programming interface (API) to enable communication with clients and other services. The API may be based on a Representational State Transfer (REST) architecture for distributed hypermedia systems. However, the underlying principles of the invention are not limited to any particular type of protocol or platform.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, it will be readily apparent to those of skill in the art that the functional modules such as wizards and other logic may be implemented as software, hardware or any combination thereof. Accordingly, the scope and spirit of the invention should be judged in terms of the claims which follow.

What is claimed is:

1. A system implemented within an online stationery service, the system comprising at least one memory for storing program code and at least one processor for processing the program code to execute:
a stationery personalization engine providing an end user with a set of selectable stationery templates, the stationery personalization engine receiving an indication that an end user has selected a particular one of the stationery templates, and generating personalized stationery with the selected template based on user input, the personalized stationery comprising an invitation to an event and requesting RSVP responses from invitees;
an RSVP service including logic for dynamically generating a network address in response to placement of a stationery order by the user, the RSVP service responsively generating an RSVP Website accessible using the network address and configured to receive the RSVP responses from invitees; and
a print module to generate and transmit a print job for printing the personalized stationery including the network address of the RSVP Website for receiving the RSVP responses;
wherein in response to an invitee accessing the Website using the network address, the RSVP service provides one or more Web pages allowing the invitee to submit an RSVP response.

2. The system as in claim 1 further comprising:
a print service for printing the stationery including the network address and for printing envelopes addressed to the invitees and mailing the stationery cards and envelopes to the invitees on behalf of the end user.

3. The system as in claim 1 wherein the network address is printed as a universal resource locator (URL).

4. The system as in claim 1 wherein the network address is printed as a QR code.

5. The system as in claim 4 wherein the network address encoded in the printed QR code is a shortened URL to make the QR code smaller in size.

6. The system as in claim 1 wherein the network address includes encoded data that represents a unique URL for each invitee such that when the invitee goes to the network address information unique to that invitee is presented.

7. The system as in claim 1 wherein the RSVP website comprises an RSVP response page comprising a listing of responses from each of the invitees.

8. The system as in claim 1 wherein, in response to typing in the network address on a computer, an invitee is provided with an RSVP response page on the RSVP website, the RSVP response page comprising:
a selectable list of options including (1) an option to indicate that the invitee will attend the event; (2) an option to indicate that the invitee will not attend the event; and (3) an option to indicate that the invitee is undecided.

9. The system as in claim 8 wherein the RSVP response page further comprises:
a listing of all current responses and comments associated with those responses; and
a first data entry field to allow the invitee to enter a public comment.

10. The system as in claim 9 wherein the RSVP response page further comprises:
a second data entry field to allow the invitee to enter a private comment to the end user.

11. The system as in claim 8 wherein, prior to being provided with the RSVP response page, the invitee is provided with an option to either log in to the online stationery service or to create an account on the online stationery service.

12. The system as in claim 1 further comprising electronic messaging logic for transmitting the network address to the RSVP website to one or more invitees within an email message or an SMS message.

13. The system as in claim 1 wherein the RSVP website comprises a web-based graphical user interface for managing RSVP responses, the GUI comprising:
a guests component including a guest overview showing statistics on RSVP responses; a guest list including a listing of invitees who have accepted; and a response feed including a listing of responses and comments from invitees.

14. The system as in claim 13 wherein the GUI further comprises:
an add guests link to allow the end user to manually add an invitee to the guest list, wherein selecting the link opens a selectable list of options including (1) an option to indicate that the invitee will attend the event; (2) an option to indicate that the invitee will not attend the event; and (3) an option to indicate that the invitee is undecided.

15. The system as in claim 13 wherein the GUI further comprises:
a notes field associated with each entry in the guest list, the notes field accessible by the end user to provide notes for each invitee on the guest list.

16. The system as in claim 1 wherein the RSVP service further comprises logic for receiving event data including pictures uploaded by invitees during or after the event and comments submitted by invitees, and wherein the RSVP website further comprises an event page containing a visual display of the pictures and comments, the event page accessible by each of the invitees.

17. The system as in claim 16 wherein the event data includes videos uploaded by invitees during the event.

18. The system as in claim 16 further comprising:
a photo story engine for evaluating metadata associated with each of the uploaded pictures, grouping the pictures into photo stories, selecting photo story templates for each of the photo stories, laying out the pictures within each of the photo story templates, and displaying the resulting photo story designs within the event page.

19. The system as in claim 16 wherein the event data is submitted to the RSVP Website using email, electronic text message such as SMS or MMS, an application running on a computer or mobile device, or a twitter hash tag.

20. The system as in claim 1 wherein a selection of recommended greeting cards is provided based on the event occasion (birthday party, anniversary party, baby shower, etc.), the stationery design chosen for the event, the personal information (name, age, etc.) and design preferences of the host and/or invitee, and the greeting cards previously ordered for this event by other invitees.
